(19) United States
(12) Patent Application Publication
(10) Pub. No.: US 2024/0209735 A1
(43) Pub. Date: Jun. 27, 2024

(54) ASSEMBLY FOR PREPARING AN INJECTABLE COMPOSITION

(71) Applicant: WEBER MINING & TUNNELLING, ROUHLING (FR)

(72) Inventors: Frank WEBER, ROUHLING (LU); Fabrice FERSTLER, Sr., GOSTINGEN (LU)

(21) Appl. No.: 18/288,422

(22) PCT Filed: Jun. 6, 2022
(86) PCT No.: PCT/EP2022/065291

§ 371 Date: Oct. 26, 2023

(30) Foreign Application Priority Data
Jun. 7, 2021 (FR) FR2105991

(51) Int. Cl. E21D 20/02; C04B 26/32; C04B 40/06; C04B 111/00; C09K 8/508

(52) U.S. Cl. CPC E21D 20/028; C04B 26/32; C04B 40/065; C09K 8/5086; E21D 20/025; C04B 2111/00715

(57) ABSTRACT

The present invention relates to an assembly (1) for preparing an injectable sealing composition for scaling an anchor bolt in a dedicated recess of a rock structure, characterised in that the assembly comprises: —at least one storage means (2) for storing at least one first component, referred to as the resin-based silicate component, —a storage means (3) for storing a second component, referred to as the diphenylmethane diisocyanate-based MDI component, —a storage means (4) for storing an organic or mineral filler, —a device for generating a first mixture (5) configured to produce a mixture combining at least an amount of the MDI component with at least an amount of filler, —a device for generating a second mixture (6) configured to produce a mixture combining at least an amount of the first mixture with at least an amount of the silicate component.

The present invention relates to the field of devices for preparing injectable compositions intended for the sealing of elements in a rock structure.

In the context of mining operations or underground exploitation, the progression of the hollowing out of tunnels jointly demands that the latter be reinforced by a consolidation system in order for the men and the machines to be sure of being able to move around safely without the fear of a landslide or subsidence of the tunnel. To this end, it is standard practice to anchor the less stable surface part of the rock to the more stable deep part of the rock. This anchoring is performed by an element placed in a borehole, this borehole being made in the structure of the rock along an axis at right angles to the plane of the tunnel wall. This element, which corresponds to a rigid bolt or to a cable bolt, is then sealed by the addition of a dedicated composition in the annular space between the bolt and the internal walls of the borehole.

In these anchoring operations, these bolts have an essentially elongate form several meters long with a lateral surface that is likely to be smooth or include a relief so as to increase the interactions of the bolt with the injected composition and therefore optimize the anchoring of the bolt inside the borehole in the rock.

The introduction of the sealing composition into the borehole can be performed using a prefilled cartridge which is introduced into the borehole then perforated upon the insertion of the bolt. Another method consists in injecting the composition into the borehole. The chemical composition can thus be injected just before the insertion of the bolt into the borehole, as in the case of a method called “pre-grouting”, or, alternatively, when the bolt comprises a duct passing through its length, by injection of the composition through the bolt once the latter is inserted, as is the case for the methods called “post-grouting”. The latter methods are implemented using injection devices which make it possible to control the quantity of sealing composition introduced into each of the boreholes and which allow an adjustment of the quantity of composition injected to the case in point, notably in the context of intervention on fractured rock structures so as to guarantee an optimization of the filling of the annular space between the bolt and the internal walls of the borehole by the injected composition.

However, the current devices do not allow an in situ and immediate adaptation of the properties of the sealing composition to the specific needs of the anchoring to be performed. Indeed, on an intervention site, a user responsible for the anchoring of bolts to the rock walls is confronted with a wide geological diversity with associated constraints that are likely to vary and result in bolting types being imposed that have different characteristics, notably in terms of length, positioning, or even of operation, as in the context of sliding bolts which, by their dynamic properties, are capable of absorbing the energy released by rock bursts, for example, which are encountered in seismic zones. Thus, for a user, the possibility of adjusting the technical properties of the sealing composition to the case in point during the anchoring operation is particularly limited, even impossible, with the solutions that are currently proposed.

The aim of the present invention is to mitigate these drawbacks by proposing a solution which makes it possible to provide a volume of sealing chemical composition that is suited to the specific needs specific to the anchoring of each bolt to a particular rock structure, while allowing a flexibility of the adjustment of the properties of the chemical composition for the purpose of an optimal adaptation of the sealing composition to the specific features of a particular anchoring operation.

Thus, one subject of the invention is an assembly for preparing an injectable sealing composition for the sealing of an anchor bolt in a dedicated recess of a rock structure, characterized in that the assembly comprises at least:
at least one storage means for at least one first component, called silicate component, comprising at least one silicate resin-based liquid component,
a storage means for a second component, called MDI component, comprising at least one liquid component based on diphenylmethane diisocyanate,
a storage means for an organic or mineral filler,
a device for generating a first mixture linked, on the one hand, to the storage means of the MDI component and, on the other hand, to the storage means of a filler, configured to produce a first mixture comprising at least a quantity of the MDI component with at least a quantity of organic or mineral filler,
a device for generating a second mixture linked, on the one hand, to the device for generating a first mixture and, on the other hand, to at least one storage means of at least the silicate component, configured to produce a mixture combining at least a quantity of the first mixture with at least a quantity of silicate component.

The invention relates also to an injectable sealing composition obtained by a preparation assembly according to the invention, characterized in that the sealing composition comprises at least:
a component called silicate component formed by at least one silicate resin comprising at least one slow-setting resin and/or one fast-setting resin and/or a setting accelerator,
a component called MDI component formed by at least one mixture of diphenylmethane diisocyanate,
an organic or mineral filler.

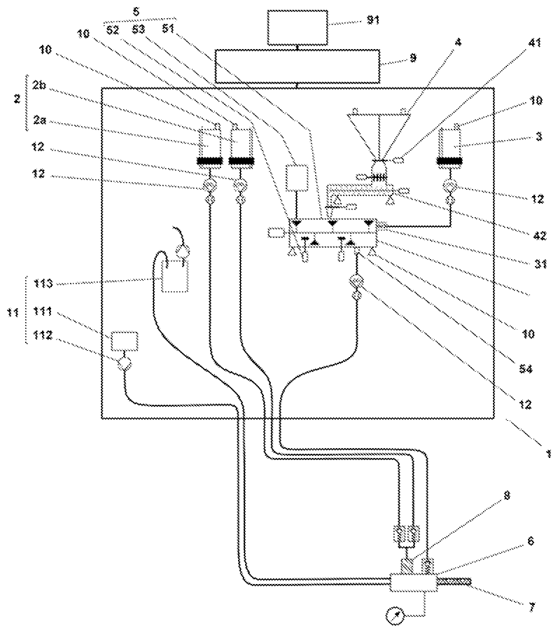

The invention will be better understood, from the following description, which relates to different preferred embodiments, given by way of nonlimiting example, and explained notably with reference to FIG. 1 which illustrates a referenced schematic representation of an exemplary assembly according to the invention.

In the present document, the term “bolt” relates both to a rigid bolt and to a cable bolt.

The invention relates to an assembly 1 for preparing an injectable sealing composition for the sealing of an anchor bolt in a dedicated recess of a rock structure, characterized in that the assembly comprises at least:
at least one storage means 2 for at least one first component, called silicate component, comprising at least one silicate resin-based liquid component,
a storage means 3 for a second component called MDI component comprising at least one liquid component based on diphenylmethane diisocyanate,
a storage means 4 for an organic or mineral filler,
a device for generating a first mixture 5 linked, on the one hand, to the storage means 3 of the MDI component and, on the other hand, to the storage means 4 of a filler, configured to produce a first mixture combining at least a quantity of the MDI component with at least a quantity of organic or mineral filler,
a device for generating a second mixture 6 linked, on the one hand, to the device for generating a first mixture 5 and, on the other hand, to at least one storage means 2 of at least the silicate component, configured to produce a mixture combining at least a quantity of the first mixture with at least a quantity of silicate component.

It should be noted that the various components that are the silicate component, the MDI component and the filler correspond to respective compositions in each of which the compound essential to each of these compositions is likely to be associated with complementary or additional components.

This preparation assembly 1 according to the invention makes it possible to ensure a storage, separated by respective means, of each of the different compounds which are used in the sealing composition intended to be injected. This preparation assembly 1 according to the invention also makes it possible to apply a production of sealing composition on the site of intervention, in quantities that are required according to the borehole and the characteristics of the bolt-type element intended to be anchored in this borehole. This capacity for preparation as close as possible to the point of intervention makes it possible to prepare the desired sealing composition at the time of its injection into the borehole. This capacity for preparation on site also makes it possible to overcome the problems of conservation of the components and compositions such as those linked to their shelf lives or to the decantation effect, which are notably encountered during their storage, in particular in the compositions that contain mineral or organic fillers.

In the preparation assembly 1 according to the invention, the mixture generation devices 5, 6 are linked to the storage means 2, 3, 4 so as to allow an adjustment of the quantity of each of the different components of the sealing composition and therefore of their respective proportions in the final composition such that, in addition to the quantity of sealing composition produced, the preparation assembly 1 is able to apply an adjustment of the sealing composition produced, and therefore of its properties, so as to render these properties optimal to meet the specific sealing and anchoring constraints of an intervention on a borehole. Thus, the sealing composition produced on the site of the injection using the preparation assembly 1 of the invention is likely to have particular properties such as a setting time, a reaction speed, gelling characteristics, such that these properties optimally meet the specific features of the anchoring to be performed, while allowing the flexibility thereof so as to be adjusted to the changes of constraints that are successively encountered when a succession of different anchoring operations is carried out.

According to the mode of operation of the assembly of the invention, the sealing composition produced is first of all generated in the form of a first mixture of MDI component and of organic or mineral filler, then in the form of a mixture combining this first preliminary mixture with a silicate component. The various stored components and mixtures produced which exhibit a viscosity are displaced in the circuit of the preparation assembly via injection pumps 12 capable of managing injection pressures, preferentially by geared pumps such as Kracht pumps. As a preferred example, these injection pumps 12 are selected for their capacity to generate injection pressures that are likely to reach values of the order of 300 bar.

According example of construction of the storage means 2, 3 of a silicate component or of an MDI component, these are produced by tanks comprising a vent associated with a desiccant cartridge ensuring that a dry atmosphere is maintained inside the storage means 2, 3. Moreover, these storage means 2, 3 are likely to be associated with heating mechanisms in order to prepare the silicate component or the MDI component in order for these to be at an optimized temperature for the production of a sealing chemical composition with the properties that are sought suited to an anchoring operation in a particular rock structure. Additionally, these storage means 2, 3 are likely to incorporate a respective mixer so as to ensure that the homogeneity of the components stored in each of these storage means 2, 3 is maintained.

According to an example of construction of the storage means 4 of an organic or mineral filler, the latter takes the form of a silo filled manually from the top and associated with a scissor valve 41 which makes it possible to select the quantity or the proportion of filler to be incorporated in the sealing composition to be produced. This silo is likely to comprise several compartments so as to allow the storage of different fillers. The opening of one or other of these compartments is done by the scissor valve 41. The storage means 4 is preferentially closed hermetically such that any entry of air takes place through desiccant cartridges, making it possible to maintain a dry atmosphere inside the storage means 4 of the filler.

According to an example of the assembly 1 of the invention corresponding to a construction variant, the assembly 1 for preparing an injectable sealing composition also comprises a device 7 for injecting at least a quantity of the second mixture, this injection device 7 being mounted at the output of the device for generating a second mixture 6. According to this construction variant of the assembly 1 of the invention, the assembly 1 is able to directly apply an injection of the sealing composition produced without the latter stagnating or having to withstand an excessively long presence, statically or dynamically, in a part of the structure of the assembly 1. Thus, the start of reaction of the different components is begun only on the mixing of the silicate component with the first mixture, this first mixture combining the MDI component with the mineral or organic filler. This start of reaction is engaged in the device for generating a second mixture 6, as close as possible to the operation of injection of the sealing composition inside the volume drilled in the rock structure. According to a specific example of this construction variant, the injection device 7 and the device for generating a second mixture 6 are incorporated in one and the same structure such that, when the preparation assembly 1 of the invention is operating, there is no latency time between the production of the sealing composition and the injection thereof.

According to another example of the assembly 1 of the invention corresponding to a variant that is likely to be combined with the variants previously detailed, the silicate component being stored by at least, on the one hand, a storage means 2a of a fast-setting silicate resin-based silicate component or of a setting accelerator and, on the other hand, a storage means 2b of a slow-setting silicate resin-based silicate component, the assembly 1 also comprises a device for generating an additional intermediate mixture 8 combining at least a proportion of fast-setting silicate resin-based silicate component or of setting accelerator with at least a proportion of slow-setting silicate resin-based silicate component. By virtue of this construction variant, the silicate component incorporated in the sealing composition exhibits anchoring speed properties which are a function of the proportions of each of the two variants of silicate component or of the proportions of silicate component, that is to say of the silicate resin and of the setting accelerator, in the final composition. It should be noted that the separate storage of the two silicate component variants in the assembly according to the invention allows the production of a sealing composition whose properties can be adjusted as a function of the constraints imposed by the conditions and the features of the anchoring operation.

According to another example of the assembly 1 of the invention corresponding to a variant that is likely to be combined with the variants previously detailed, the assembly 1 also comprises a dispensing command and control unit 9 on a device for generating a mixture 5, 6, 8 of at least two stored components among the storage means 2, 2a, 2b, 3, 4 of the assembly 1. This command and control unit 9 makes it possible to apply a refined adjustment of the proportions of each of the components which feed a device for generating a mixture 5, 6, 8. According to a specific example of this construction variant, this unit 9 applies a control of the dispensing of each of the stored components, even also of the feeding of each of the devices for generating a mixture 5, 6, 8. It should be noted that, according to an exemplary embodiment, this command and control unit 9 incorporates one or more memory units comprising one or more programs for managing the dispensing of the different stored components as a function of the sealing chemical composition sought. According to another exemplary embodiment, the command and control unit 9 is also connected to one or more of the devices for generating a mixture 5, 6, 8 such that the command unit 9 also ensures the management of the quality of the mixtures produced and notably the quality of their respective homogeneities by avoiding any risk of decantation.

According to another specific example of this construction variant that is likely to be combined with the variants previously detailed, the dispensing command and control unit 9 is associated with at least one sensor 10 for evaluating at least one external parameter. Depending on the sensor 10 concerned and the variable being evaluated, this construction variant is likely to allow the command and control unit 9 to apply an adjustment of the quality of the sealing chemical composition and therefore of the necessary properties, according to the constraining specific features identified in the environment of the injection operation, such as a relative humidity probe or a thermometer. Additionally, the sensor 10 is likely to inform the command and control unit 9 as to the operation of one or other of the elements of the assembly 1 of the invention such as the state of the stocks of the components present in the storage means 2, 2a, 2b, 3, 4, their respective temperatures or relative humidities, the proportion of the components currently being dispensed at each of the devices for generating a mixture 5, 6, 8 by different dedicated probes such as weighing sensors, or even the appearance of mechanical malfunctions or prolonged shutdowns by suitable sensors, such as, for example, flowmeters. Thus, in the case of a prolonged shutdown of certain devices of the preparation assembly of the invention, the command and control unit 9 is able to apply a resumption of operation, possibly temporary, of these devices so as to prevent a stagnation of all or part of the mixture of the sealing composition in the preparation circuit of this composition and notably in one or other of the devices for generating a mixture 5, 6, 8 in order for the mixture produced not to experience a decantation and a limitation, even a prevention, of the reactions of the different components present.

According to another specific example of this construction variant that is likely to be combined with the variants previously detailed, the dispensing command and control unit 9 is associated with at least one user interface 91. According to a preferred arrangement, this user interface 91 makes it possible to take control over autonomous operation of the command and control unit 9. Additionally, this user interface 91 makes it possible to apply a particular programming of the command unit 9 or an adjustment of all or part of a program incorporated in the command and control unit 9. This user interface 91 allows an intervention prior to the actuation of the preparation but also while the preparation assembly of the invention is operating, that is to say during an injection operation.

According to another specific example of this construction variant that is likely to be combined with the variants previously detailed, the dispensing command and control unit 9 is associated with the injection device 7 and configured to be actuated when the injection device 7 is operating. Thus, according to this construction example, the injection operation actuates the implementation of the preparation of the sealing composition according to the method planned or likely to be adjusted to one or other of the parameters identified by one or other of the probes 10 of the assembly 1. Additionally, the injection device 7 incorporates a pressurestat so that, when an injection pressure corresponding to the value of a filled hole is reached, the command and control unit 9 actuates an automated stoppage of the injection operation.

According to another example of the assembly 1 of the invention corresponding to a variant that is likely to be combined with the variants previously detailed, the device for generating the first mixture 5 involves at least one mixing mechanism 51. According to a specific example of construction of the mixing mechanism 51, the latter incorporates various blades and scrapers disposed in the form of baseplates or inclined blades arranged to pivot about a central shaft inside a cylindrical tank. This mixing mechanism 51 is likely to be arranged vertically or horizontally. By way of an additional variant, this mixing mechanism 51 incorporates at least one dispersing machine 52 which optimizes the homogenization of the mixture during the mixing operation. Likewise, it is possible to envisage associating the mixing mechanism 51 with a vacuum pump 53 configured to generate a partial vacuum inside the device for generating the first mixture 5 so as to eliminate the bubbles that are likely to form and be incorporated in the mixture produced during the operation of mixing of this mixture. According to another specific example of construction of the mixing mechanism 51, the latter comprises, at its output, a strainer 54 configured to apply a filtration of the mixture generated such that the mixture dispensing circuit and notably the mixture pumping devices are not damaged by solid fillers of excessive volume. As a nonlimiting example, the strainer 54 has a mesh size of between 50 μm and 2000 μm, preferentially between 100 μm and 500 μm, ideally of the order of 200 μm. As a specific example of this construction variant, the organic or mineral filler originating from the dedicated storage means 4 is handled by gravity by a micro-doser 42 associated with a clod-breaking device which ensures a homogenization of the filler and of its possible organic or mineral additives. As an example, the micro-doser 42 incorporates a worm screw which manages the progress of the filler. The clod-breaking device is likely to comprise vertical blades which complement the worm screw of the micro-doser 42 and avoid a build-up of clots in the context of the preparation of the filler prior to the mixing thereof with the MDI component in the device for generating the first mixture 5. The join between the micro-doser 42 and the device for generating the first mixture 5 involves a scissor valve capable of sealing the partial vacuum generated by the vacuum pump 53 in the device for generating the first mixture 5. In addition, the quantity of MDI component originating from the dedicated storage means 3 is poured into the device for generating the first mixture 5 via an associated geared pump 12 via an adjustable non-return valve 31 and under the monitoring of a flowmeter or of a balance associated with the device for generating the first mixture 5. As an example, this valve 31 only allows a one-way transition as a function of pressure thresholds exceeded in the MDI component displacement circuit. The dosage of quantities of filler and of MDI component dispensed in the device for generating the first mixture 5 is controlled by one or more weighing sensors 10 incorporated in the device for generating the first mixture 5.

According to another example of the assembly 1 of the invention corresponding to a variant that is likely to be combined with the variants previously detailed, the device for generating the second mixture 6 involves at least one static mixer. This static mixer is likely to incorporate the features of a mixture of known type. It takes the form of a duct intended to be passed through by the various components of the final sealing composition, this duct comprising several obstacles and reliefs positioned over the travel of the components inside the duct such that several turbulences are generated between the different components being displaced to culminate in a homogenization of the mixture.

According to another example of the assembly 1 of the invention corresponding to a variant that is an alternative to the variant previously detailed but likely to be combined with the other variants, the device for generating the second mixture 6 involves at least one dynamic mixer. This dynamic mixer is likely to incorporate the features of a mixer of known type, notably involving a motor which pivotingly actuates several blades in rotation about an axis.

According to another example of the assembly 1 of the invention corresponding to a variant that is likely to be combined with the variants previously detailed, the assembly 1 comprises at least one frame-forming support structure arranged to allow a joint transportation of the various constituent elements of the assembly 1. The installation of the various constituent elements and devices of the preparation assembly 1 of the invention on a common support structure allows the preparation assembly 1 to be displaced as close as possible to the site of injection of the prepared sealing composition. According to a specific example of construction of this construction variant, the assembly 1 of the invention comprises a support structure mounted on wheels or incorporated in a vehicle so as to be easy to move around.

According to another example of the assembly 1 of the invention corresponding to a variant that is likely to be combined with the variants previously detailed, the assembly 1 also comprises a device 11 for cleaning the injection device 7 which makes it possible to prevent a hardening of the sealing composition likely to remain in the injection device 7 once the injection operation is finished. This cleaning device 11 comprises a storage means 111 of a cleaning product linked to an input of the device for generating a second mixture 6 via an actuation pump 112 of the cleaning circuit. A spraying of cleaning product in the device for generating a second mixture 6 will then also make the product pass through the injection device 7. Alternatively or in addition, the cleaning device 11 comprises a partial-vacuum pump 113 which makes it possible to apply a cleaning by suction by recovering the residues of prepared sealing composition in a dedicated extraction circuit.

The invention relates also to an injectable sealing composition obtained by a preparation assembly according to the invention, characterized in that the sealing composition comprises at least:
a component, called silicate component, formed by at least one silicate resin comprising at least a slow-setting resin and/or a fast-setting resin and/or a setting accelerator,
a component, called MDI component, formed by at least one mixture of diphenylmethane diisocyanate,
an organic or mineral filler.

According to a particular example of preparation of the injectable composition, the MDI component is formed by a mixture of pre-polymer of diphenylmethane-4,4′-diisocyanate and/or the isomers thereof.

According to another particular example of preparation of the injectable composition that is likely to be combined with the preceding example, the MDI component also comprises a small quantity of diphenylmethane-2,4′-diisocyanate.

According to an example of injectable composition of the invention corresponding to a production variant, the proportion by volume of the mixture of MDI component and filler with respect to the silicate component is preferentially of the order of three volumes of mixture of MDI component and filler for two volumes of silicate component possibly mixed with a setting accelerator.

According to another example of injectable composition of the invention corresponding to a production variant that is likely to be combined with the preceding variant, the proportion by weight of filler with respect to the MDI component is preferentially of the order of one weight of filler for two weights of MDI component.

The command and control unit 9 incorporates one or more memory units comprising one or more programs for managing the dispensing of the various stored components capable of setting the preparation assembly according to the invention in operation such that the prepared sealing chemical composition exhibits at least one of the characteristics of the injectable compositions stated previously.

Obviously, the invention is not limited to the embodiments described and/or is represented in the attached drawings. Modifications remain possible, notably from the point of view of the construction of the various elements or by the replacement of technical equivalents, without in any way departing from the scope of protection of the invention.

1. An assembly for preparing an injectable sealing composition for the sealing of an anchor bolt in a dedicated recess of a rock structure, wherein the assembly comprises at least:
at least one storage means of at least one first component, called silicate component, comprising at least one silicate resin-based liquid component,
a storage means of a second component, called MDI component, comprising at least one liquid component based on diphenylmethane diisocyanate,
a storage means of an organic or mineral filler,
a device for generating a first mixture linked, on the one hand, to the storage means of the MDI component and, on the other hand, to the storage means of a filler, configured to produce a first mixture combining at least a quantity of the MDI component with at least a quantity of organic or mineral filler,
a device for generating a second mixture linked, on the one hand, to the device for generating a first mixture and, on the other hand, to at least one storage means of at least the silicate component, configured to produce a mixture combining at least a quantity of the first mixture with at least a quantity of silicate component.

2. The assembly for preparing an injectable sealing composition as claimed in claim 1, wherein the assembly for preparing an injectable sealing composition also comprises a device for injecting at least a quantity of the second mixture, this injection device being mounted at the output of the device for generating a second mixture.

3. The preparation assembly as claimed in claim 1, wherein, the silicate component being stored by at least, on the one hand, a storage means of a fastsetting silicate resin-based silicate component or of a setting accelerator and, on the other hand, a storage means of a slowsetting silicate resin-based silicate component, the assembly also comprises a device for generating an additional intermediate mixture combining at least a proportion of fast-setting silicate resin-based silicate component or of setting accelerator with at least a proportion of slow-setting silicate resin-based silicate component.

4. The preparation assembly as claimed in claim 1, wherein the assembly also comprises a dispensing command and control unit on a device for generating a mixture of at least two stored components among the storage means of the assembly.

5. The preparation assembly as claimed in claim 4, wherein the dispensing command and control unit is associated with at least one sensor for evaluating at least one external parameter.

6. The preparation assembly as claimed in claim 4, wherein the dispensing command and control unit is associated with at least one user interface.

7. The preparation assembly as claimed in claim 4,
wherein the assembly for preparing an injectable sealing composition also comprises a device for injecting at least a quantity of the second mixture, this injection device being mounted at the output of the device for generating a second mixture, and
wherein the dispensing command and control unit is associated with the injection device and configured to be actuated when the injection device is operating.

8. The preparation assembly as claimed in claim 1, wherein the device for generating the first mixture involves at least one mixing mechanism.

9. The preparation assembly as claimed in claim 1, wherein the device for generating the second mixture involves at least one static mixer.

10. The preparation assembly as claimed in claim 1, wherein the device for generating the second mixture involves at least one dynamic mixer.

11. The preparation assembly as claimed in claim 1, wherein the assembly comprises at least one frame-forming support structure arranged to allow a joint transportation of the different constituent elements of the assembly.

12. An injectable sealing composition obtained by a preparation assembly as claimed in claim 1, wherein the sealing composition comprises at least:
a component, called silicate component, formed by at least one silicate resin comprising at least a slow-setting resin and/or a fastsetting resin and/or a setting accelerator,
a component, called MDI component, formed by at least a mixture of diphenylmethane diisocyanate,
an organic or mineral filler.
